(19) United States
(12) Patent Application Publication
(10) Pub. No.: US 2023/0229895 A1
(43) Pub. Date: Jul. 20, 2023

(54) Automatic Selection of Quantization and Filter Pruning Optimization Under Energy Constraints

(71) Applicant: Google LLC, Mountain View, CA (US)

(72) Inventors: Claudionor Jose Nunes Coelho, Jr., Redwood City, CA (US); Piotr Zielinski, New Providence, NJ (US); Aki Kuusela, Palo Alto, CA (US); Shan Li, San Carlos, CA (US); Hao Zhuang, San Jose, CA (US)

(21) Appl. No.: 18/007,871

(22) PCT Filed: Jun. 2, 2021
(86) PCT No.: PCT/US2021/035493

§ 371 Date: Dec. 2, 2022

Related U.S. Application Data
(60) Provisional application No. 63/034,532, filed on Jun. 4, 2020.

(51) Int. Cl. G06N 3/0495; G06N 3/092

(52) U.S. Cl. CPC G06N 3/0495; G06N 3/092

(57) ABSTRACT

Systems and methods for producing a neural network architecture with improved energy consumption and performance tradeoffs are disclosed, such as would be deployed for use on mobile or other resource-constrained devices. In particular, the present disclosure provides systems and methods for searching a network search space for joint optimization of a size of a layer of a reference neural network model (e.g., the number of filters in a convolutional layer or the number of output units in a dense layer) and of the quantization of values within the layer. By defining the search space to correspond to the architecture of a reference neural network model, examples of the disclosed network architecture search can optimize models of arbitrary complexity. The resulting neural network models are able to be run using relatively fewer computing resources (e.g., less processing power, less memory usage, less power consumption, etc.), all while remaining competitive with or even exceeding the performance (e.g., accuracy) of current state-of-the-art, mobile-optimized models.

### RELATED APPLICATIONS

This application claims priority to and the benefit of U.S. Provisional Patent Application No. 63/034,532, filed Jun. 4, 2020, which is hereby incorporated by reference in its entirety.

### FIELD

The present disclosure relates generally to neural network architecture. More particularly, the present disclosure relates to systems and methods for producing an architecture optimized for performance and decreased energy consumption.

### BACKGROUND

Neural networks often rely on computationally expensive calculations to achieve the desired accuracy and speed in performing a given task. The increasing deployment of neural network models on battery-powered mobile devices or in other resource-constrained environments presents challenges to design neural networks which operate under tighter resource constraints.

The efficiency of current state-of-the-art neural network architectures (e.g., convolutional neural network architectures used to perform object detection) are highly dependent on the optimal selection of hyperparameters. Hyperparameters influence the overall structure and operation of the network and are typically outside the training loop of the network. As the values are not trained, they are typically manually selected. In view of this difficulty, common approaches to improving the efficiency of neural networks follow basic intuition: make the network smaller to decrease the computational cost.

Network architecture searches have implemented this goal by searching for a neural network architecture which achieves the desired performance targets under size constraints. Although this approach has been successful, with strong performances on many benchmarks, previous architecture search approaches have several limitations. For instance, the vast size of typical search spaces places certain practical limitations on the types and arrangements of blocks within the neural network architecture, limiting the creativity of network designers to implement bespoke neural networks.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for quantizing a neural network model while accounting for performance. The method includes receiving, by a computing system comprising one or more computing devices, a reference neural network model. The method further includes modifying, by the computing system, a reference neural network model to generate a candidate neural network model. The candidate neural network model is generated by selecting one or more values from a first searchable subspace and one or more values from a second searchable subspace, where the first searchable subspace corresponds to a quantization scheme for quantizing one or more values of the reference neural network model, and the second parameter corresponds to a size of a layer of the reference neural network model. The method further includes evaluating one or more performance metrics of the candidate neural network model.

In other example aspects, the method further includes outputting a new neural network model based at least in part on the one or more performance metrics.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures.

FIGS. 1-4 depict graphical diagrams of an example neural architecture search approach according to example embodiments of the present disclosure.

FIG. 5 depicts a flow chart diagram of an example method to perform a neural architecture search according to example embodiments of the present disclosure.

FIG. 6 depicts a block diagram of an example computing system according to example embodiments of the present disclosure.

FIG. 7 depicts a block diagram of an example computing device according to example embodiments of the present disclosure.

FIG. 8 depicts a block diagram of an example computing device according to example embodiments of the present disclosure.

FIG. 9 depicts a plot of example scaling factor curves according to example embodiments of the present disclosure.

FIG. 10 depicts example test results obtained according to example embodiments of the present disclosure.

Reference numerals that are repeated across plural figures are intended to identify the same features in various implementations.

### DETAILED DESCRIPTION

### Overview

Generally, the present disclosure is directed to systems and methods for performing a neural architecture search to produce a neural network model architecture that provides an improved tradeoff between performance and energy consumption. In some embodiments, systems and methods of the present disclosure may produce an optimized neural network model by optimizing the existing architecture of a provided reference neural network model.

More particularly, the energy consumption required to execute a neural network model can be estimated to the first order by summing the amount of energy required to perform each operation in the execution of the neural network model. Given a neural network with, for example, a dense layer having Nᵢ inputs and Nₒ outputs and corresponding to a bias set B, the execution of only that layer would require the retrieval of Nᵢ·Nₒ weights, Nₒ biases, and Nᵢ inputs from memory before calculating Nᵢ·Nₒ multiplication and accumulation (MAC) operations. Convolutional layers also require large numbers of MAC, which scale with each additional filter in the layer.

In addition to the bare quantity of calculations, the energy consumption or cost associated with executing a neural network model also increases with the precision with which model values are represented numerically. High precision numbers require more bits for representation within the computing system, and this increased bitwidth (which can also be referred to in some instances as bit depth) is associated with several energy costs, including increased storage costs, retrieval costs, and calculation costs.

Thus, decreasing the number of MAC operations and/or limiting the precision of at least some of the values within the neural network may decrease the associated energy costs of executing the neural network model. In some cases, reducing the precision (e.g., bitwidth) of values within a given neural network may be accomplished by quantization, which includes methods of mapping higher precision numbers into bins corresponding to lower precision numbers. However, lower precision numbers may not capture as much detail as higher precision numbers.

Prior network architecture search methodologies failed to provide a meaningful way to optimize the quantization of the model in view of the characteristics of MAC operations. In particular, there are practically limitless variations of network architectures, with varying quantities and configurations of layers. Each variation provides a different quantity and complexity of MAC operations, affecting the energy consumption of the model. To render a tractable search problem, network searches have generally investigated limited search spaces, such as with combinations and configurations of predefined motifs or building blocks. These search limitations hinder the complexity and adaptability of the neural network models.

Advantageously, systems and methods of the present disclosure expand the power of network search methods to overcome the above-mentioned challenges. In some embodiments, a network search space is constructed to correspond to the architecture (e.g., the arrangement, configuration, and/or number of layers) of a given neural network model, permitting efficient search for optimizing the neural network structure without limitation to the complexity of the neural network model. For example, in some embodiments, a neural network model may comprise a layer having a quantity of filters (e.g., a convolutional layer) or output units (e.g., in a dense layer). Systems and methods of the present disclosure may compensate for any precision lost in the quantization processes by admitting at least two degrees of freedom in the network search space: at least one degree of freedom for varying the quantization scheme for quantizing one or more parameters of the layer within the given neural network model, and at least one degree of freedom for varying (e.g., decreasing or increasing) the size of the layer. The size of the layer may correspond to, in some embodiments, a number of filters and/or output units contained in the layer. In some embodiments, the neural network search may evaluate candidate neural networks in which detail obscured by aggressive quantization is recovered with an increased number of filters and/or outputs contained in the same layer and/or in a subsequent layer.

Joint search systems and methods according to aspects of the present disclosure stand in stark contrast to past network searches, which have failed to recognize the benefits of jointly searching multiple search spaces to balance the precision of layer values with the number of filters in the layer. Specifically, past techniques have failed to appreciate the effect of quantization on the optimum number of filters in a layer, often quantizing a model only as a final step after layer parameters are established. For example, each filter of a layer in a deep learning network represents a cutting plane that cuts the hyperspace through the non-linear activation function, and that, for some models, reducing the precision of the original input and parameter space may increase the number of filters needed to accurately represent the hyperplane. Furthermore, in some models, quantization may render some filters redundant. For example, two different filters—e.g., with coefficients {−0.63, 0.21} and {−0.15, 0.79} may represent the same hyperplane after, e.g., binary quantization. As a result, some filters may be removed after quantization of some models without reducing the accuracy of the quantized model.

Systems and methods according to the present disclosure resolve the deficiencies of prior search methods by searching a network search space which contains at least two subspaces: at least one subspace corresponding to a quantization scheme for quantizing one or more parameters of a layer within a given neural network model, and at least one subspace corresponding to a number of filters and/or number of output units contained in the same layer. In this manner, a model may be quantized while accounting for performance. Advantageously, adjusting the number of filters and/or output units jointly with the quantization of the layer values may improve a trade-off between performance (e.g., accuracy) and energy consumption.

More particularly, although the quantity of calculations may increase with the number of filters and/or output units contained in the layer, example network architecture searches according to the present disclosure may operate to decrease the energy consumption of the model in view of both the quantity of calculations (e.g., MAC) as well as the computational cost of each MAC. For instance, the complexity of the required calculations for processing a layer of the neural network may vary substantially depending on the bitwidth of each of the numbers involved in the calculations. In some implementations, the energy cost of common operations as a function of the number of bits can be estimated by Equation (1).

energy(bits)=a(bits)²+b(bits)+c (1)

The coefficients a, b, and c can be estimated from empirical data (e.g., data may be collected experimentally and/or extracted from publications, such as M. Horowitz, “1.1 Computing's Energy Problem (and What We Can Do About It),” 2014 IEEE Int. Solid-State Circuits Conf. Digest of Tech. Papers (ISSCC), San Francisco, Calif., 2014, pp. 10-14, doi: 10.1109/ISSCC.2014.6757323). Example coefficients fitted to the Horowitz data are presented in Table 1, in units of pJ/bit.

TABLE 1

| | a | b | c |
|---|---|---|---|
| Fixed point add | | 0.0031 | 0 |
| Fixed point multiply | 0.0030 | 0.0010 | 0 |
| Floating point 16 add | | | 0.4 |
| Floating point 16 multiply | | | 1.1 |
| Floating point 32 add | | | 0.9 |
| Floating point 32 multiply | | | 3.7 |
| SRAM access | 0.02455/64 | −0.2656/64 | 0.8661/64 |
| DRAM access | | 20.3125 | 0 |

In some examples, an energy cost estimate, e.g., according to Equation (1), may provide a relative energy cost for comparing one or more neural networks or neural network layers. For example, the energy costs associated with operations common to the neural network(s) and/or layers under comparison may, in some examples, be omitted from and/or neglected by the estimation method(s) to compare only the energy cost differences associated with the differences between the neural network(s) and/or layer(s) under comparison.

In some examples, systems and methods according to the present disclosure reduce the energy consumption by a model by quantizing one or more values or sets of values (e.g., the inputs, weights, filters, and/or biases for a layer) in view of both the quantity of bits for the values as well as the cost of the necessary types of operations to be applied to the values.

For instance, if two values (e.g., selected from a weight, an input, and/or a bias) are floating point numbers, both the multiplication and addition are performed in floating point. However, if both inputs and outputs are binary, for example, a multiplication can be implemented by a single XOR gate, and an addition can be implemented as an increment/decrement logic, which are computationally less expensive than a normal MAC. In this manner, for example, varying the quantization scheme can advantageously reduce energy requirements of the operations, as multipliers typically have quadratic energy consumption in terms of the number of bits, but other representations may have linear behavior (which is even lower than addition by a constant factor), such as in the case of XNOR and AND operations.

In some examples, selecting a quantization scheme could correspond to selecting the values contained in a bit tuple for quantizing a value. For instance, floating point values are typically represented by (−1)^{sign bit} (2^{exponent bits})(mantissa bits), and the bits required to express the value may be expressed as the bit tuple (sign bits, exponent bits, mantissa bits). A quantization scheme may correspond to a quantized bit tuple which characterizes the quantity of bits allocated to each category (i.e., sign bits, exponent bits, and/or mantissa bits). For example, the following quantization schemes may be expressed as bit tuples:

Modified binary: In one example, a modified binary quantization scheme corresponds to a bit tuple (0, c, 1), where the sign is assumed to be (−1°). In one example, c=0 (zero bits are used to store an exponent) and the exponent is assumed to be 0 to represent values 0 and 1. In some examples, c=0, and the exponent is assumed to be a constant value to produce a desired scaling of the modified binary values. In further examples, the exponent may also be a constant which is stored in c bits. In some examples, the constant exponent may be defined the same or differently for each of one or more values quantized according to the modified binary quantization scheme. For instance, each of one set of one or more inputs, outputs, weights, and/or filters may be quantized using one constant exponent (e.g., representable with one value of c), and each of another set of one or more inputs, outputs, weights, and/or filters (e.g., in another layer) may correspond to another constant exponent (e.g., representable with another value of c). In this manner, a constant exponent may be used to scale one or more sets of quantized values, such as to provide for a fixed and/or shared exponent among the one or more sets of values.

Binary: In one example, a binary quantization scheme corresponds to bit tuple (1, c, 0). In one example, c=0, the exponent is assumed to be 0, and the mantissa is assumed to be 1 (or −1) to represent values −1 and 1. As discussed above with respect to some embodiments of a modified binary quantization scheme, in some examples, c=0, and the exponent is assumed to be a constant value to produce a desired scaling of the binary values. In further examples, the exponent may also be a constant which is stored in c bits. In some examples, the constant exponent may be defined the same or differently for each of one or more values quantized according to the binary quantization scheme. For instance, each of one set of one or more inputs, outputs, weights, and/or filters may be quantized using one constant exponent (e.g., representable with one value of c), and each of another set of one or more inputs, outputs, weights, and/or filters (e.g., in another layer) may correspond to another constant exponent (e.g., representable with another value of c). In this manner, a constant exponent may be used to scale one or more sets of quantized values, such as to provide for a fixed and/or shared exponent among the one or more sets of values.

Ternary: In one example, a ternary quantization scheme corresponds to a bit tuple (−1, c, 1). In one example, c=0, and the exponent is assumed to be 0 to represent values −1, 0, and 1. As discussed above with respect to some embodiments of a binary quantization scheme and a modified binary quantization scheme, in some examples, c=0, and the exponent is assumed to be a constant value to produce a desired scaling of the ternary values. In further examples, the exponent may also be a constant which is stored in c bits. In some examples, the constant exponent may be defined the same or differently for each of one or more values quantized according to the ternary quantization scheme. For instance, each of one set of one or more inputs, outputs, weights, and/or filters may be quantized using one constant exponent (e.g., representable with one value of c), and each of another set of one or more inputs, outputs, weights, and/or filters (e.g., in another layer) may correspond to another constant exponent (e.g., representable with another value of c). In this manner, a constant exponent may be used to scale one or more sets of quantized values, such as to provide for a fixed and/or shared exponent among the one or more sets of values.

e-quant: In one example, an exponential quantization (“e-quant”) scheme corresponds to a representation with e bits, having the bit tuple (1, e−1, 0), where there is 1 bit for the sign and e−1 bits for the exponent, and the mantissa is assumed to be a fixed value of, e.g., 1.

m-quant: In one example, a mantissa quantization (“m-quant”) scheme corresponds to a representation with m bits, with 1 bit for the sign and m−1 bits for the mantissa magnitude, where the exponent is assumed to be 0. The 1 bit used for the sign may correspond to a signed mantissa, e.g., bit tuple (1, 0, m−1), or, in some examples, an extra bit for representing the mantissa in two's complement notation, e.g., bit tuple (0, 0, m).

When each of two numbers subject to a MAC are quantized with the same or different quantization schemes, the required number of bits for the MAC calculation can be determined. For example, one calculation for the required number of bits follows the algorithm provided below, although the number of bits may be calculated or estimated using any suitable algorithm or other method.

| def get_multiplier_and_accumulator_bits(qi, qw): | |
|---|---|
| # qi=quantize(input), qw=quantize(weight) | |
| # Assume: q.is_mantissa −> mantissa quantization (m-quant) | |
| # | q.ibits −> number of bits to the left of the decimal |
| # | point if is_mantissa |
| # | q.bits −> number of bits |
| # | q.is_sign −> number is signed |
| # | q.is_exp −> it is exponent quantization (e-quant) |
| # | q.is_binary == q.is_mantissa and q.bits == 1 |
| # | q.is_ternary == q.is_mantissa and q.bits == 2 and |
| # | q.ibits == 1 |
| # | q.non_binary == not(q.is_binary or q.is_ternary or |
| # | q.is_exp) |
| # | q.max / q.min represents the maximum and minimum |
| # | values for the exponent quantization |
| # | q.max = (1 << (q.bits − q.is_signed − 1)) − 1 or |
| other | |
| # | value specified by user |
| # | q.min =−1 << (q.bits − q.is_signed − 1) or other |
| value | |
| # | specified by user |

```
if qi.non_binary and qw.non_binary:
  size(*) = qi.bits + qw.bits
  size(*−>+) = size(*)
elif qi.non_binary or qw.non_binary:
  if qi.non_binary:
    a = qi
    b = qw
  else:
    a = qw
    b = qi
  if b.is_binary or b.is_ternary:
    bits = 1 − a.is_sign
  else:
    bits = b.max − b.min + (not(a.is_sign) and b.is_sign)
  size(*) = a.bits + bits
  size(*−>+) = size(*)
else:
  if qi.is_exp:
    bitsi = qi.max − qi.min
    mbitsi = qi.bits − qi.is_sign
  else:
    bitsi = 0
    mbitsi = 0
  if qw.is_exp:
    bitsw = qw.max − qw.min
    mbitsw = qw.bits − qw.is_sign
  else:
    bitsw = 0
    mbitsw = 0
  if mbitsi == 0 and mbitsw == 0:
    size(*) = max(qw.bits, qi.bits)
  else:
    size(*) = max(mbitsi, mbitsw) + 1 + (qi.is_sign or
```

qw.is_sign)

```
  bits = bitsi + bitsw + (qi.is_sign or qw.is_sign)
  size(*−>+) = bits
size(+) = size(*−>+) + ceil(log2(number of operations /
output)
return size(*), size(*−>+)
```

The above algorithm accepts, as an example, a quantized input qi and a quantized weight qw, and returns a number of bits required to complete one multiplication and accumulation operation as size(*->+).

Systems and methods of the present disclosure may employ any suitable method of quantization, or multiple methods of quantization, depending on the application. For example, one type of values within the neural network may be quantized according to a first quantization scheme, while another type of values may be quantized according to a second quantization scheme. For instance, the weights applied in a neural network layer may be quantized according to a first quantization scheme, the biases for the layer may be quantized according to the first quantization scheme or, alternatively, a second quantization scheme, and the inputs to the layer may be quantized to the first or the second quantization scheme, or, alternatively, a third quantization scheme. The first, second, and third quantization schemes may be the same or different, including all the same or all different. Additionally, each layer of a multi-layer neural network model may be quantized the same or differently, as desired.

In some examples, the selection of different quantization schemes offers different advantages. For instance, m-quantization can offer increased precision for a given number of bits as compared to e-quantization, but e-quantization can offer increased dynamic range for the same number of bits. In this manner, for example, the selection of different quantization schemes for one or more different values and/or layers may confer advantages determined by the different roles of the different layers. Additionally, or alternatively, the selection of different quantization schemes for one or more different values and/or layers may be used by systems and methods of the present disclosure to compensate for any performance characteristic (e.g., accuracy) which may otherwise decline.

Of further advantage, in some embodiments, systems and methods of the present disclosure construct the network search space to correspond to the architecture of a given neural network model. While systems and methods according to the present disclosure may operate without such limitation as part of an expansive search space for many permutations of various neural network architectures, a carefully limited search space may yield satisfactory results in shorter time. By constructing a search space which corresponds to an existing neural network architecture, the search space may be constrained without limitation to the complexity of the neural network architecture subject to the optimization process.

For instance, a neural network model may be selected for optimization. A network search space may be constructed to correspond to the number and configuration of layers of the selected model. For example, a network search space may include searchable subspaces which correspond to the size, type, and/or number of layers within the selected model. For a given layer, for instance, systems and methods of the present disclosure may define a first searchable subspace which includes values which correspond to a first quantization scheme for representing one or more values of the layer (e.g., one or more values or types of values selected from inputs, weights, outputs, biases, activation functions, etc.). In one example, values contained in a bit tuple may be selected from one or more first searchable subspaces. For example, selecting a bit tuple of (0, 0, m) may correspond to an m-quant quantization scheme, where a value for m is selected from a searchable subspace. In another example, selecting a bit tuple of (1, e−1, 0) may correspond to an e-quant quantization scheme, where a value for e is selected from a searchable subspace. In another example, a searchable subspace may correspond to values corresponding to one or more of binary, modified binary, ternary, floating point, or other numerical quantization or representation schemes.

Multiple additional subspaces may also be defined as needed to correspond to independently searchable quantization schemes for quantizing multiple additional values within the layer. In some embodiments, the network search space for the given layer may also include at least a second searchable subspace which includes values which correspond to the size of the layer. In some examples, the second searchable subspace may include values corresponding to a quantity of filters contained in the layer (e.g., in a convolutional layer). In some examples, the second searchable subspace may include values corresponding to a quantity of output units contained in the layer (e.g., in a dense layer). In this manner, each of one or more layers may correspond to one or more searchable subspaces. Additionally, or alternatively, one or more values contained within one or more layers may collectively be represented by one subspace.

In some embodiments, a given neural network model for optimization may contain a plurality of layers. Each of the layers may present the same or different energy consumption or cost during execution and/or training as compared to other layers. In some embodiments, systems and methods according to the present disclosure may more aggressively decrease the energy cost of the more costly layers while retaining greater precision and/or additional filters in less costly layers. For instance, in one embodiment, a multi-layer neural network model may be optimized by searching the network search space for each layer in order of decreasing energy cost of the layer. In this manner, more aggressive energy savings in the beginning of the optimization process may be employed while enjoying flexibility to tune the performance of the model by retaining greater precision and/or additional filters in the cheaper layers.

The network search spaces for the layers of a multi-layer model may be searched in other suitable orders, or any order specified by a user. For instance, a given multi-layer network model may have constraints requiring the number of filters in a downstream layer to correspond to the number of filters in an upstream layer. In one example, the order may correspond to the order of layers from the input to the output of the model. In another example, the order may include various sub-ordering. For example, the network search spaces may be ordered overall in order of decreasing layer energy cost, except where constraints or dependencies would require alternate ordering among a subset of the layers. In this manner, the advantages of energy-ranked ordering may be wholly or partially realized while respecting the dependencies and complexities of the given neural network model.

When conducting a network architecture search according to systems and methods of the present invention, it may be desirable to characterize the overall improvement to a given neural network model in terms of one or more performance characteristics or metrics. In one example, the one or more performance characteristics includes a score or metric which may be based upon or reflect a number of bits or energy. When an optimization process has two goals, e.g., optimize parameter 1 and parameter 2, a weighted combination of each parameter into a single score may reflect a user's desired trade-off between the optimization of the two parameters. For example, in some embodiments, a single score may account for both the energy cost savings as well as the retained (or improved) performance of a model (e.g., validation accuracy) of systems and methods according to the present disclosure. In one embodiment, the calculation of the score may include explicit terms which correspond to an acceptable decrease in model performance which may be exchanged for a specified amount of energy savings. For example, one formulation of a suitable score includes a scaling factor calculated according to Equation (2).

$$scaling factor = 1 + p \cdot \frac{{log}_{r} ( stress \cdot \frac{reference energy cost}{candidtae energy cost} )}{100} \qquad ( 2 )$$

In Equation (2), a permissible level of lost performance p is expressed as a percentage, the targeted energy reduction r is expressed as a multiplicative factor, stress is a weighting parameter which shifts the function, the reference energy cost corresponds to an energy cost of a reference neural network model (or layer or layers thereof), and the candidate energy cost corresponds to an energy cost of the neural network model (or layer or layers thereof) that is compared to the reference. In this embodiment, this equation captures some aspects of an explicit tradeoff that may be expressed in the question, “if I reduce the energy of my model by r times (as expressed by the ratio of the reference energy cost to the candidate energy cost), what percent p degradation in accuracy, for example, am I willing to tolerate?”

In some embodiments, the score is calculated differently based on the relative size of the candidate and the reference. For instance, a first score may be calculated according to a first metric when a candidate model is smaller than a reference model, and a second score may be calculated according to a second metric when a candidate model is larger than a reference model. In some examples, the second metric is different than the first metric, such as a different method or calculation. In some examples, the second metric may comprise modifications to the first metric. For instance, the first metric may be calculated according to Equation (2) with one value for stress, and the second metric may be calculated according to Equation (2) with another value for stress. In the same manner, any of p, r, or stress may be varied between the first and second metric.

In calculation of a score that accounts for both performance and energy cost (e.g., of a model or of a layer within the model), the energy cost can be measured, predicted, or estimated, as needed. For example, in some examples, the reference energy cost, candidate energy cost, or both are measured when executing and/or training the respective models and/or layers on a target device. The measurement may thus correspond to a real-world energy cost when the models and/or layers are deployed on a target device (e.g., a battery-powered device, such as a mobile device, an embedded device, and/or some other resource-constrained environment). In other examples, the target device may be simulated or emulated by a host device, enabling the estimation of a real-world energy cost for executing and/or training a model and/or layers thereof on the target device. For example, the table given above can be used as look up tables to directly compute the energy cost of a model layer or layers given description of the layer or layers. Additionally, or alternatively, the energy cost can be estimated or predicted using energy cost models (e.g., including an algorithm as discussed above to estimate a number of bits required for one or more calculations). In one example, the energy cost model may be a differentiable function. One such example includes an energy cost model which employs a polynomial representation, such as illustrated in Equation (1). In some examples, the energy cost may be estimated by the size of the model or models being evaluated.

In some embodiments, the network search is part of an iterative search process to generate new neural network models. For instance, a controller model may be employed to generate a candidate neural network model by modifying a reference neural network model according to one or more values selected from the network search space, such as from a first searchable subspace corresponding to a quantization scheme for quantizing one or more values within the reference model and from a second searchable subspace corresponding to a number of filters contained in a layer within the reference model. The candidate model may share the same architecture as the reference model, except for the modifications made by the controller model according to the values selected from the network search space. The candidate model may then be compared to the reference model, such as with a score assigned to the candidate model. The controller model may then repeat the generation of candidate models until the desired score is achieved or some other stopping criterion is met. In this manner, for example, a new neural network model may be output based on the desired one or more performance metric(s).

In some embodiments, the score received by one or more candidate models is provided as feedback to the controller model to guide the future selection of values from the network search space. For example, the score may be used as part of a probabilistic search algorithm to search the network search space. As another example, in some implementations, the controller model can include a reinforcement learning agent. For each of the plurality of iterations, the computing system can be configured to determine a reward based, at least in part, on the one or more evaluated performance characteristics associated with a candidate neural network model. In some embodiments, the reward is positively correlated to one performance characteristic of interest (e.g., accuracy) and negatively correlated to another performance characteristic of interest (e.g., energy cost). The controller model may then be updated based on the reward, such as by modifying one or more parameters of the controller model. In some implementations, the controller model may include a neural network (e.g., a recurrent neural network). Thus, the controller model can be trained to modify the reference neural network model and/or the candidate neural network model(s) in a manner that maximizes, optimizes, or otherwise adjusts a performance characteristic associated with the resulting candidate neural network model.

As another example, in an evolutionary scheme, the performance of the most recently proposed candidate can be compared to a best previously observed performance from a previous candidate to determine, for example, whether to retain the most recently proposed candidate or to discard the most recently proposed candidate and instead return to a best previously observed candidate. To generate the next iterative candidate, the controller model can perform evolutionary mutations on the candidate selected based on the comparison described above.

Embodiments of the present invention convey a number of technical advantages and benefits. As one example, the systems and methods of the present disclosure are able to generate energy-optimized and performance-optimized neural network models much faster and using much fewer computing resources (e.g., less processing power, less memory usage, less power consumption, etc.), as compared to, for example, naive search techniques which search a network search space which includes many different configurations of neural network architectures. As another result, highly complex neural network architectures may be optimized by systems and methods of the present disclosure without resorting to vast and intractable search spaces, which demand a large computational cost for searching. As another result, the systems and methods of the present disclosure are able to generate (e.g., create and/or modify) new neural architectures that are better suited for resource-constrained environments while maintaining satisfactory performance characteristics, as compared to, for example, search techniques which do not jointly search degrees of freedom for both quantization and the quantity of filters for a layer. That is, the resulting neural architectures are able to be run relatively faster and using relatively fewer computing resources (e.g., less processing power, less memory usage, less power consumption, etc.), all while remaining competitive with or even exceeding the performance (e.g., accuracy) of current state-of-the-art models. Thus, as another example technical effect and benefit, the search technique described herein can automatically find significantly better models than existing approaches and achieve a new state-of-the-art trade-off between performance and energy cost/size.

With reference now to the Figures, example embodiments of the present disclosure will be discussed in further detail.

### Example Model Arrangements

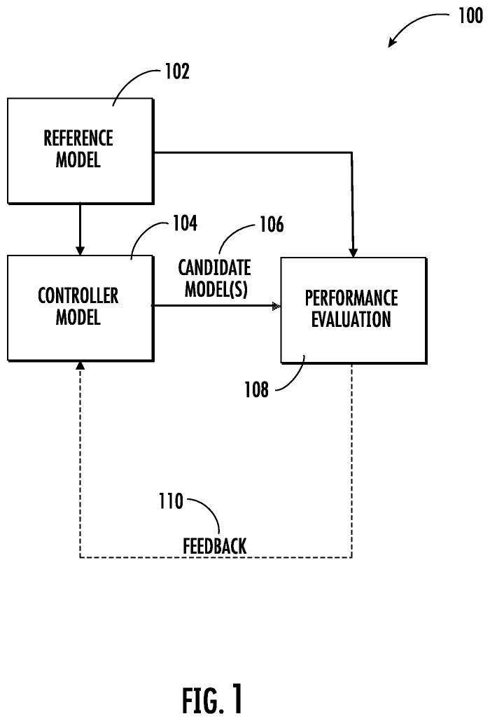

FIG. 1 depicts an example system 100 that is configured to accept a reference neural network model 102 as an input to a controller model 104 (e.g., the reference neural network 102 may be identified, selected from a set of predefined models, uploaded, or otherwise specified by a user). The controller model 104 may then search a network search space corresponding to the neural network architecture of the reference neural network model 102. For example, the controller model 104 may search a search space comprising a first searchable subspace corresponding to a quantization scheme for quantizing one or more values within a layer of the reference neural network model 102 and a second searchable subspace corresponding to a size of the layer (e.g., the number of filters within the layer and/or number of output units). Based on values selected from the searchable subspaces, the controller model 104 may generate one or more candidate models 106 for evaluation by a performance evaluation subsystem 108. The performance evaluation subsystem 108 accepts the one or more candidate models 106 for evaluating the relative change(s) in performance (including, e.g., energy cost, accuracy, and the like) relative to the reference model 102. In examples comprising an iterative search, based on this comparison, the performance evaluation subsystem 108 may optionally provide feedback 110 to the controller model 104. In some examples, the feedback 110 may inform the controller model 104 that a satisfactory candidate model 106 has been generated, and to stop generating further candidates 106; the feedback 110 may inform the controller model 104 that certain candidate models 106 outperformed other candidate models 106, permitting the controller model 104 to engage in probabilistic search methods to navigate the network search space; the feedback 110 may comprise a reward to reward the controller model 104 for producing higher performing candidate models 106 so that the controller model 104 may employ reinforcement learning technologies to improve its search of the network search space.

As another example, in an evolutionary scheme, the performance evaluation subsystem 108 can retain in memory the candidate having the best previously observed performance and compare the incoming candidate models 106 thereto. The performance evaluation subsystem 108 may then determine, for example, whether to retain or discard one or more of the most recently proposed one or more candidate models 106. Based on the feedback 110 received by the controller model 104 from the performance evaluation subsystem 108, the controller model 104 can perform evolutionary mutations on a candidate model selected based on the comparison described above.

In some implementations, the performance evaluation subsystem 108 may evaluate the performance of candidate models 106 using pre-trained model values inherited from the reference neural network model 102, subject to the modifications that may have been applied by the controller model 104 (e.g., quantization). In this manner, the performance evaluation subsystem 108 may quickly evaluate the candidate models 106 for comparison to the reference model 102. In other implementations, each candidate model 106 can be wholly trained from scratch (e.g., no values are inherited from previous iterations or the reference model 102).

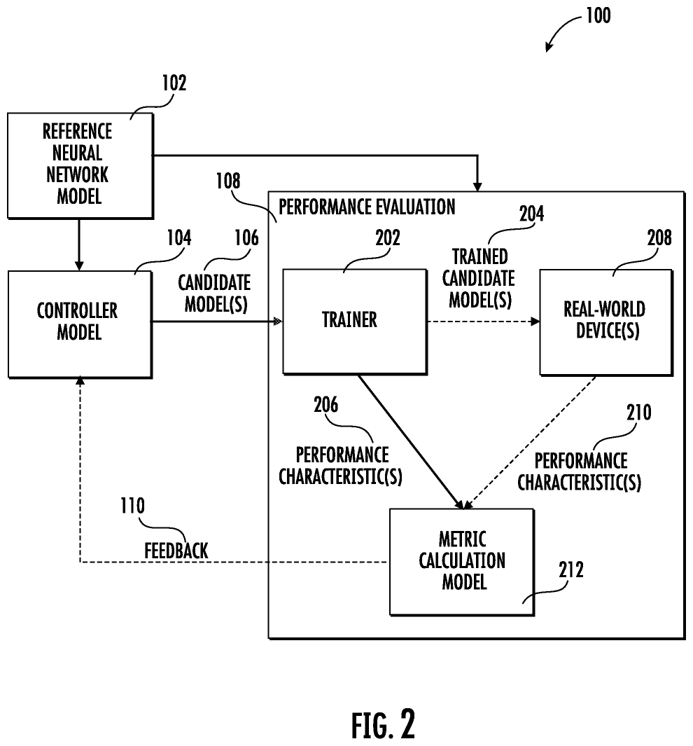

In some implementations, the example system 100 may be configured as shown in FIG. 2. The performance evaluation subsystem 108 may comprise a trainer 202 which trains the one or more candidate models 106 to produce one or more trained candidate models 204. The trained models 204 may be optionally trained using inherited trained values from the reference model 102 as seed values or using inherited trained values directly, or both. The trained models 204 may also be trained from scratch.

The trainer 202 may directly evaluate one or more performance characteristics of the trained candidate model(s) 204 directly. For example, one or more performance characteristics 206 of the trained candidate model(s) 204 may include a validation accuracy and/or an energy cost associated with the training and/or the execution of the one or more trained candidate model(s) 204. For example, the energy cost can be directly computed using one or more look up tables or formulas which directly translate from model characteristics (e.g., number/types of operations and quantization scheme) to an energy cost value. Additionally, or alternatively, the one or more trained candidate models may be passed to one or more real-world devices 208 (which may include simulations, emulations, and/or functional estimations or approximations thereof) for evaluation of one or more performance characteristics 210. For example, one or more performance characteristics 210 of the trained candidate model(s) 204 may include a validation accuracy and/or an energy cost associated with the training and/or the execution of the one or more trained candidate model(s) 204 on the real-world device(s) 208.

The one or more performance characteristic(s) 206 and/or one or more of the performance characteristics 210 may be passed to a metric calculation model 212 for calculation of a performance metric, such as a score. In some examples, the performance metric may include the one or more performance characteristic(s) 206, the one or more of the performance characteristics 210, or some combination thereof, such as a combination calculated according to Equation (2). In some embodiments, the performance metric is positively correlated to one performance characteristic of interest (e.g., accuracy) and negatively correlated to another performance characteristic of interest (e.g., energy cost). In some embodiments, the metric calculation model 212 may pass through unchanged the one or more performance characteristic(s) 206 and/or the one or more of the performance characteristics 210. The feedback 112 may then be output from the metric calculation model 212 to the controller model 104, which may incorporate the feedback in any suitable manner, such as the configurations discussed herein.

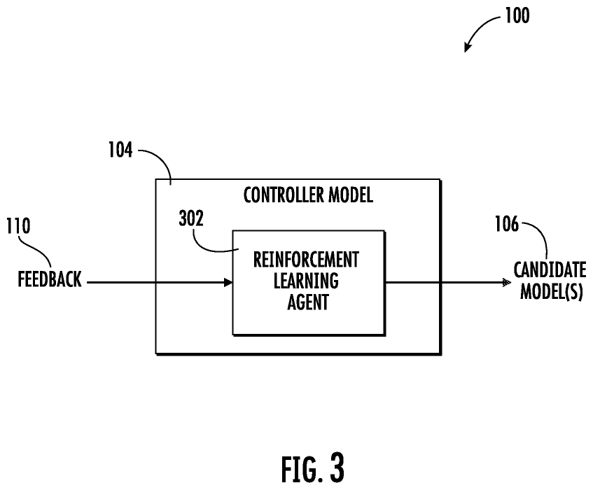

In some embodiments, the controller model 104 comprises a reinforcement learning agent 302, as shown in FIG. 3. The reinforcement learning agent 302 may operate in a reinforcement learning scheme to select values from the searchable subspaces of the network search space to generate the candidate neural network model(s) 106. For example, at each iteration, the controller model 104 can apply a policy to select the values from the searchable subspaces to generate the candidate neural network model(s) 106, and the reinforcement learning agent 302 can update and/or inform the policy based on the feedback 110 received by the controller model 104. As one example, the reinforcement learning agent 302 can comprise a recurrent neural network, or any suitable machine learning agent. In one embodiment, the feedback 110 can comprise a reward or other measurements of loss, regret, and/or the like (e.g., for use in gradient-based optimization schemes), based on the one or more performance characteristic(s) 206 and/or the one or more of the performance characteristic(s) 210 processed by the metric calculation model 212, such as a score generated thereby. Example implementations of the present disclosure may employ a gradient-based reinforcement learning approach to find solutions (e.g., Pareto optimal solutions) for the search problem (e.g., a multi-objective search problem). Reinforcement learning can be used because it is convenient, and the reward is easy to customize. However, in other implementations, other search algorithms like evolutionary algorithms can be used instead. For example, new candidate neural network models 106 can be generated through randomized mutation.

In some embodiments, the one or more performance characteristic(s) 206 and/or the one or more performance characteristics 210 may be evaluated using the actual task (e.g., the “real task”) for which the reference neural network model 102 is being optimized or designed. For instance, the one or more performance characteristic(s) 206 and/or the one or more performance characteristics 210 may be evaluated using a set of training data that will be used to train the resulting model that includes the optimized neural network model. However, in other embodiments, the one or more performance characteristic(s) 206 and/or the one or more performance characteristics 210 may be evaluated using a proxy task that has a relatively shorter training time and also correlates with the real task. For instance, evaluating the performance characteristics using the proxy task may include using a smaller training and/or verification data set than the real task (e.g., down-sampled versions of images and/or other data) and/or evaluating the real task for fewer epochs than would generally be used to train the model using the real task.

According to another aspect, in some implementations, the one or more performance characteristics 210 can include a real-world energy cost associated with implementation of the new network structure on a real-world mobile device. More particularly, in some implementations, the search system can explicitly incorporate energy cost information (e.g., using a functional representation thereof, such as is disclosed herein) into the main objective so that the search can identify a model that achieves a good trade-off between accuracy and energy cost. In some implementations, real-world energy costs can be directly measured by executing the model on a particular platform (e.g., a mobile device such as the Google Pixel device). In further implementations, various other performance characteristics can be included in a multi-objective function that guides the search process, including, as examples, power consumption, user interface responsiveness, peak compute requirements, and/or other characteristics of the generated network models.

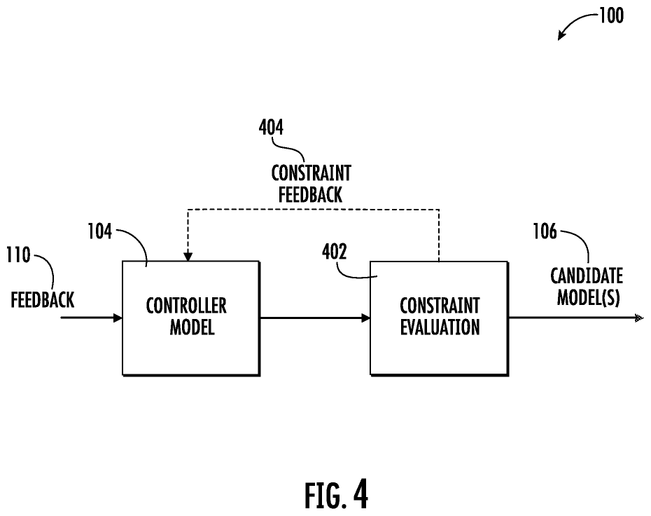

In some embodiments, the system 100 may evaluate candidate models 106 in a constraint evaluation module 402, as shown in FIG. 4. A constraint evaluation module 402 may be included in the controller model 104 in some examples, and additionally, or alternatively, may be included in the performance evaluation subsystem 108 in some examples. The constraint evaluation module 402 may evaluate threshold determinations regarding the candidate models 106 (e.g., dimensionality and/or other compatibility concerns, etc.) and return constraint feedback 404 to the controller model 104 prior to engaging in a computationally expensive training in the trainer 202. In this manner, threshold determinations regarding performance may be performed and prior to passing the candidate models 106 to the next stage. The controller model 104 may then incorporate the constraint feedback 404 to better select values from the searchable subspaces (e.g., using probabilistic or reinforcement learning methods) to meet the constraints.

In some embodiments, the performance evaluation subsystem 108 may comprise training data for training the candidate models 106, advantageously avoiding the transmission of training data between the controller model 104 and the trainer 202. For instance, when training data contains sensitive information, such as personal data, medical data, government data, or other such sensitive information, the performance evaluation subsystem 108 may perform tests with the sensitive data locally and only communicate the performance metric as feedback 110 (which may include the one or more performance characteristic(s) 206, the one or more of the performance characteristics 210, or some combination thereof, such as a score), which advantageously can maintain a high level of anonymity and/or other privacy measures around the training data used to evaluate the performance of the candidate models 106. In the same manner, a constraint evaluation module 402 may locally evaluate the candidate models 106 prior to training and return constraint feedback 404, without explicitly requiring the disclosure of the constraints to the controller model 104. Advantageously, when the performance evaluation subsystem 108 is a system which previously operated and/or trained the reference neural network model 102, preserving the configuration of the architecture of the reference neural network model 102 (subject to the modifications by the controller model 104) permits the performance evaluation subsystem 108 to readily accept variations thereof and retain much of the relevant know-how for optimally training neural network models of that architecture. For instance, a performance evaluation subsystem 108 may comprise a system which is desired to be optimized for energy cost and/or performance on execution, but is already optimized in other aspects, including hyperparameters governing aspects of the network architecture. By preserving the configuration of the architecture of the reference neural network model 102, subject to the modifications by the controller model 104, the systems and methods according to the present disclosure can retain any advantages of prior investment in optimizing the hyperparameters governing the network's architecture.

### Example Methods

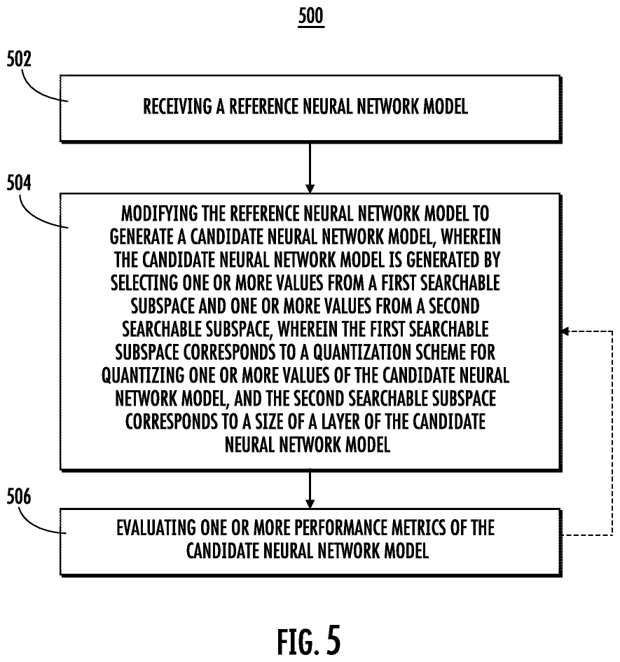

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can receive a reference neural network model. The reference neural network model may be received in any suitable manner, such as via transmission to or within the computing system, such as from local or remote storage or via networked communications channels.

At 504, the computing system can modify the reference neural network model to generate a candidate neural network model. The candidate neural network model may be generated by modifying the reference neural network model according to one or more values selected from a first searchable subspace and one or more values selected from the second searchable subspace. The first searchable subspace corresponds to a quantization scheme for quantizing one or more values of the candidate neural network model, and the second searchable subspace corresponds to a size of a layer (e.g., the quantity of filters and/or output units contained in the layer) of the candidate neural network model.

In some implementations, the computing system at 504 modifies the reference neural network model using a controller model. The controller model, in some examples, comprises a reinforcement learning agent and/or a probabilistic search model.

At 506, the computing system can evaluate one or more performance metrics of the candidate neural network model. In some examples, the one or more performance metrics of the candidate neural network model comprises an estimated energy consumption of the candidate neural network model, and in some examples, the one or more performance metrics comprises a real-world energy consumption associated with implementation of the candidate neural network model on a real-world device.

In some implementations, the method 500 includes outputting a score based on the one or more performance metrics from 506 to the controller model of the computing system for iterative modification of the reference neural network model at 504. In example iterative methods, the computing system may receive the output of 506 at 504 and update the controller model based at least in part on the one or more performance metrics before outputting a new neural network model based at least in part on the one or more performance metrics (e.g., using the updated controller model). In some examples, the update may comprise a reward based at least in part on the one or more performance metrics.

In some examples, the one or more performance metrics comprises a scaling factor which negatively correlates to a difference in energy consumption between the candidate neural network model and the reference neural network model. In some examples, the scaling factor is applied to scale an accuracy metric.

### Example Devices and Systems

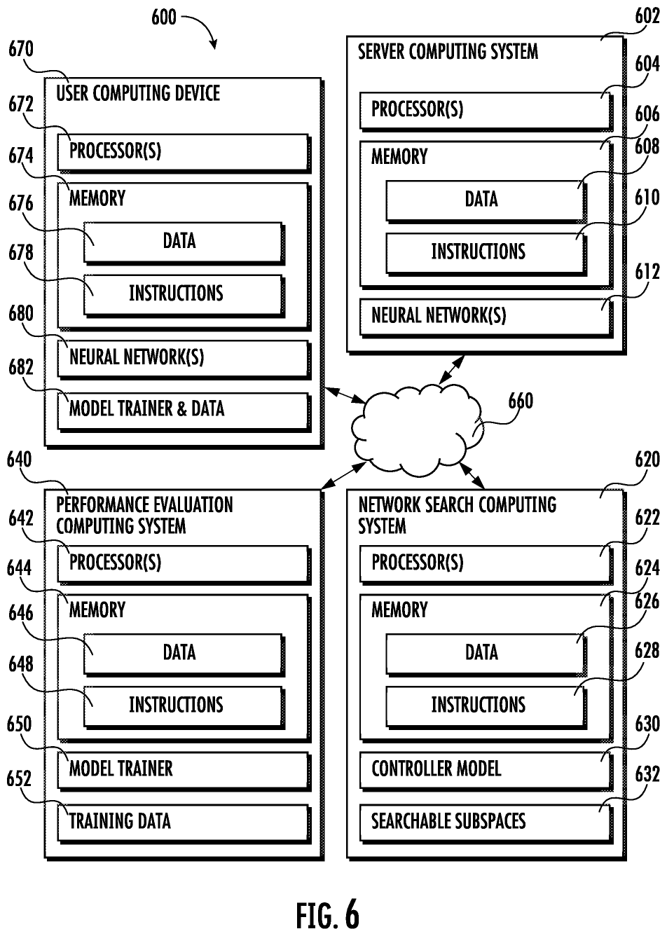

FIG. 6 depicts a block diagram of an example computing system 600 for optimizing a neural network model according to example embodiments of the present disclosure. It is contemplated that systems and methods of the present disclosure may be implemented in a number of suitable arrangements, including entirely local applications which run within one or more interconnected computing devices, and also including distributed computing systems executing one or more portions of the methods disclosed herein on each of one or more interconnected computing devices. Although FIG. 6 depicts one example configuration of a computing system for operating the systems and methods of the present disclosure, it is to be understood that other alternative configurations of computing devices remain within the scope of the present disclosure.

The example system 600 can include a server computing system 602, a network search computing system 620, and a performance evaluation computing system 640 that are communicatively coupled over a network 660. In some examples, the system 600 may include a user computing device 670.

The server computing system 602 includes one or more processors 604 and a memory 606. The one or more processors 604 can be any suitable processing device (e.g., a processor core, a microprocessor, an ASIC, a FPGA, a controller, a microcontroller, a GPU, a neural network accelerator, etc.) and can be one processor or a plurality of processors that are operatively connected. The memory 606 can include one or more non-transitory computer-readable storage mediums, such as RAM, SRAM, DRAM, ROM, EEPROM, EPROM, flash memory devices, magnetic disks, etc., and combinations thereof. The memory 606 can store data 608 and instructions 610 which are executed by the processor 604 to cause the server computing system 602 to perform operations.

In some implementations, the server computing system 602 includes or is otherwise implemented by one or more server computing devices. In instances in which the server computing system 602 includes plural server computing devices, such server computing devices can operate according to sequential computing architectures, parallel computing architectures, or some combination thereof.

The server computing system 602 can store or otherwise include one or more neural network models 612. For example, the one or more neural network models 612 can include a reference neural network model to be optimized according to the present disclosure. The neural network models 612 can be uploaded to the server computing system 602 for storage thereon, and in some embodiments, the server computing system 602 hosts or otherwise operates the one or more neural network models 612 in an application. In some implementations, the systems and methods can be provided as a cloud-based service (e.g., by the server computing system 602). Users can provide a pre-trained or pre-configured neural network model as the neural network(s) 612.

The network search computing system 620 may receive information describing the neural network(s) 612 from the server computing system 602. The network search computing system 620 may include one or more processors 622 and a memory 624. The one or more processors 622 can be any suitable processing device (e.g., a processor core, a microprocessor, an ASIC, a FPGA, a controller, a microcontroller, a GPU, a neural network accelerator, etc.) and can be one processor or a plurality of processors that are operatively connected. The memory 624 can include one or more non-transitory computer-readable storage mediums, such as RAM, SRAM, DRAM, ROM, EEPROM, EPROM, flash memory devices, magnetic disks, etc., and combinations thereof. The memory 624 can store data 626 and instructions 628 which are executed by the processor 622 to cause the network search computing system 620 to perform operations. In some implementations, the network search computing system 620 includes or is otherwise implemented by one or more server computing devices. The network search computing system 620 can be separate from the server computing system 602 or can be a portion of the server computing system 602.

The network search computing system 620 may also include a controller model 630 as described above with reference to FIGS. 1-4. The controller model 630 may receive information describing the neural networks 612 and define searchable subspaces 632, as described above. The controller model 630 may operate to select one or more values from the searchable subspaces 632 to generate one or more candidate neural network model(s), wherein the candidate neural network model(s) are generated by modifying a neural network received from the neural networks 612 according to values selected from the searchable subspaces 632, as described above.

As described above with reference to FIGS. 2-4, the network search computing system 620 may pass the one or more candidate neural network models to the performance evaluation computing subsystem 640. The performance evaluation computing subsystem 640 includes one or more processors 642 and a memory 644. The one or more processors 642 can be any suitable processing device (e.g., a processor core, a microprocessor, an ASIC, a FPGA, a controller, a microcontroller, a GPU, a neural network accelerator, etc.) and can be one processor or a plurality of processors that are operatively connected. The memory 644 can include one or more non-transitory computer-readable storage mediums, such as RAM, SRAM, DRAM, ROM, EEPROM, EPROM, flash memory devices, magnetic disks, etc., and combinations thereof. The memory 644 can store data 646 and instructions 648 which are executed by the processor 642 to cause the performance evaluation computing subsystem 640 to perform operations. In some implementations, the performance evaluation computing subsystem 640 includes or is otherwise implemented by one or more server computing devices. The performance evaluation computing subsystem 640 can be separate from the network search computing system 620 or can be a portion of the network search computing system 620.

The performance evaluation computing subsystem 640 can include a model trainer 650 that trains the candidate model(s) received from the network search computing system 620, as well as, in some examples, a reference neural network 612 received from the server computing system 602. The model trainer 650 may employ various training or learning techniques, such as, for example, backwards propagation of errors. In some implementations, performing backwards propagation of errors can include performing truncated backpropagation through time. The model trainer 650 can perform a number of generalization techniques (e.g., weight decays, dropouts, etc.) to improve the generalization capability of the models being trained. The model trainer 650 may include computer logic utilized to provide desired functionality. The model trainer 650 can be implemented in hardware, firmware, and/or software controlling a general purpose processor. For example, in some implementations, the model trainer 650 includes program files stored on a storage device, loaded into a memory and executed by one or more processors. In other implementations, the model trainer 650 includes one or more sets of computer-executable instructions that are stored in a tangible computer-readable storage medium such as RAM hard disk or optical or magnetic media.

In particular, the model trainer 650 can train or pre-train one or more neural network models (e.g., candidate neural network models) based on training data 652. The training data 652 can include labeled and/or unlabeled data. In some examples, the training data 652 is stored locally on the performance evaluation computing system 640. In some examples, the training data 652 is accessed through the network 660 from a server computing system, such as the server computing system 602 (e.g., to inherit pre-trained model data from the neural network model(s) 612).

The network 660 can be any type of communications network, such as a local area network (e.g., intranet), wide area network (e.g., Internet), or some combination thereof and can include any number of wired or wireless links. In general, communication over the network 660 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some examples, the performance evaluation computing system 640 evaluates one or more performance metrics associated with the trained candidate neural network models. For example, the performance evaluation computing system 640 may store one or more trained candidate neural network model(s) in the performance evaluation computing system memory 644, and then use or otherwise implement the trained candidate neural network model(s) using the one or more processors 642. In some implementations, the performance evaluation computing system 640 can implement multiple parallel instances of the trained candidate neural network model(s). In this manner, the performance evaluation computing system 640 may evaluate one or more performance metrics, such as an accuracy metric and/or an estimated, simulated, and/or calculated energy cost metric associated with the trained candidate neural network model(s).

In some implementations, if a user has provided consent, the training examples can be provided by a user computing device 670 (e.g., based on communications previously provided by the user of the user computing device 670). Thus, in such implementations, model trainer 650 can train using user-specific communication data received from the user computing device 670. In some instances, this process can be referred to as personalizing the model being trained.

The user computing device 670 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 670 includes one or more processors 672 and a memory 674. The one or more processors 672 can be any suitable processing device (e.g., a processor core, a microprocessor, an ASIC, a FPGA, a controller, a microcontroller, a GPU, a neural network accelerator, etc.) and can be one processor or a plurality of processors that are operatively connected. The memory 674 can include one or more non-transitory computer-readable storage mediums, such as RAM, SRAM, DRAM, ROM, EEPROM, EPROM, flash memory devices, magnetic disks, etc., and combinations thereof. The memory 674 can store data 676 and instructions 678 which are executed by the processor 672 to cause the user computing device 670 to perform operations.

The user computing device 670 can also include one or more user input components that receive user input. For example, the user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The user computing device 670 can store or include one or more neural network models 680, which may include the one or more candidate neural network models generated by the network search computing system 620. In some implementations, candidate neural network models can be received from the network search computing system 620 and/or the performance evaluation computing system 640 over network 660, stored in the user computing device memory 674, and then used or otherwise implemented by the one or more processors 672. In some implementations, the user computing device 670 can implement multiple parallel instances of one or more of the neural networks 680.

In some examples, the neural network models 680 may be trained by the user computing device 670 using the model trainer and data 682. In this manner, a real-world energy consumption or cost associated with the training of the neural network model(s) 680 may be calculated or measured on the user computing device 670. In some examples, the neural network model(s) 680 are trained and/or pre-trained by the performance evaluation computing system 640 prior to loading onto the user computing device 670. The user computing device 670 may then execute and/or apply the neural networks 680 to evaluate one or more performance metrics, such as accuracy and/or an energy cost metric. For example, the user computing device may measure a real-world energy cost associated with applying the trained neural network model(s) 680 received from the performance evaluation computing system 640.

The network search computing system 620 may receive feedback from the performance evaluation computing system 640 and/or the user computing device 670 (e.g., via the network 660). As described above with reference to FIGS. 1-4, the feedback may be used to update the controller model 630. For example, the controller model 630 can include a controller (e.g., an RNN-based controller) and a reward generator. The controller model 630 can cooperate with the model trainer(s) 650 and/or 682 to train the controller 630. The network search computing system 620 and/or the performance evaluation computing system 640 can also optionally be communicatively coupled with various other devices (not specifically shown) that measure performance parameters of the generated networks (e.g., mobile phone replicas which replicate mobile phone performance of the networks).

In some examples, each of the network search computing system 620 and the performance evaluation computing system 640 can be included in or otherwise stored and implemented by the server computing system 602 that communicates with the user computing device 670 according to a client-server relationship. For example, the functionality comprised by the network search computing system 620 and the performance evaluation computing system 640 may be provided as a portion of a web service (e.g., a neural network model optimization service).

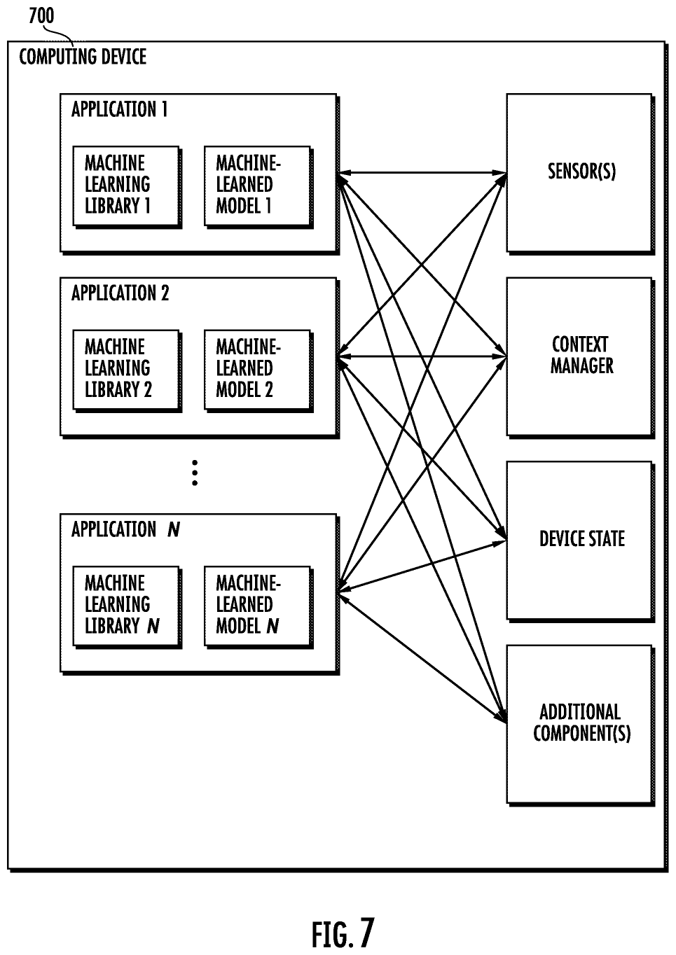

FIG. 7 depicts a block diagram of an example computing device 700 that performs operations according to example embodiments of the present disclosure. The computing device 700 can be, for example, any one or all of a server computing system 602, a network search computing system 620, a performance evaluation computing system 640, and a user computing device 670.

The computing device 700 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7, each application can communicate with a number of other components of the computing device 700, such as, for example, one or more sensors, a context manager, a device state component, and/or additional components. In some implementations, each application can communicate with each device component using an API (e.g., a public API). In some implementations, the API used by each application is specific to that application.

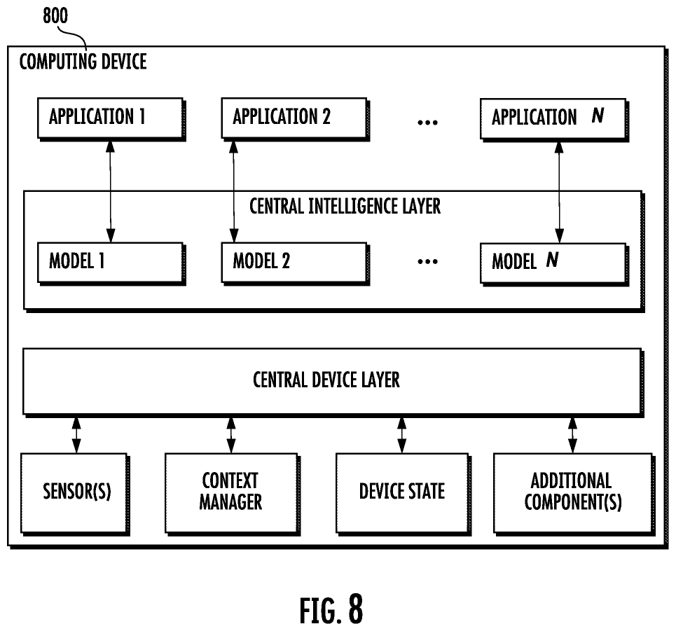

FIG. 8 depicts a block diagram of an example computing device 800 that operates according to example embodiments of the present disclosure. The computing device 800 can be, for example, any one or all of a server computing system 602, a network search computing system 620, a performance evaluation computing system 640, and a user computing device 670.

The computing device 800 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 8, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 800.

The central intelligence layer can communicate with a central device data layer. The central device data layer can be a centralized repository of data for the computing device 800. As illustrated in FIG. 7, the central device data layer can communicate with a number of other components of the computing device, such as, for example, one or more sensors, a context manager, a device state component, and/or additional components. In some implementations, the central device data layer can communicate with each device component using an API (e.g., a private API).

As one example, the systems and methods of the present disclosure can be included or otherwise employed within the context of an application, a browser plug-in, or in other contexts. Thus, in some implementations, the models of the present disclosure can be included in or otherwise stored and implemented by a user computing device such as a laptop, tablet, or smartphone. As yet another example, the models can be included in or otherwise stored and implemented by a server computing device that communicates with the user computing device according to a client-server relationship. For example, the models can be implemented by the server computing device as a portion of a web service (e.g., a web email service).

### Test Results

The following example embodiment illustrates the implementation of various aspects of the present disclosure.

For example, an energy efficient neural network model may be desired which has comparable validation accuracy to a reference model while using less energy. For instance, a 2% drop in accuracy may be exchanged for using 3 times less energy. Following Equation (2), a scaling factor for calculating a score may be calculated with p=2, r=3, and stress=1. The energy costs may be estimated by the size of the models (e.g., the number of parameters and number of activation bits). In one example, reference energy cost=100,000.

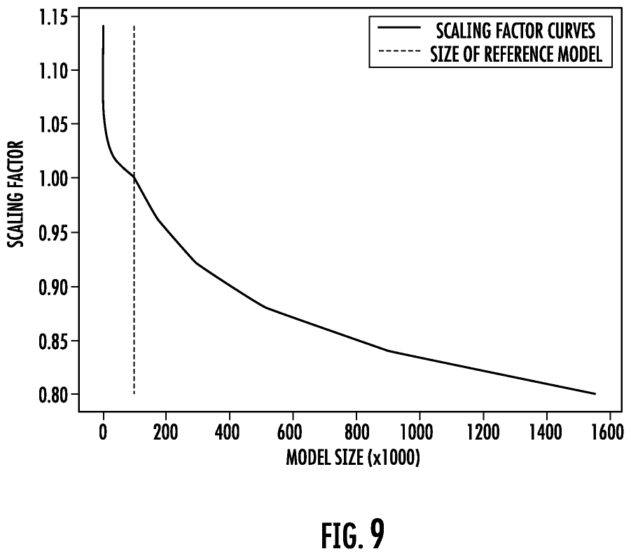

In some embodiments, a different scaling factor may be applied when a candidate neural network has a greater energy cost than the reference model than is applied when the candidate neural network has a lower energy cost than the reference model. For example, the scaling factor may be plotted as shown in FIG. 9, where the above-calculated scaling factor is applied when the model size is larger than the reference model size. When the model size is smaller than the reference model size, other parameters may be used to calculate the scaling factor, e.g., p=8, r=2, and stress=1.

In one example, the reference model may contain the following layers, where layer names starting with “conv2d” correspond to a convolutional layer, layer names starting with “act” correspond to an activation layer, and the layer name “dense” corresponds to the final dense layer:

| | |
|---|---|
| conv2d_0_m | filters=16 |
| act0_m | relu |
| conv2d_1_m | filters=32 |
| act1_m | relu |
| conv2d_2_m | filters=64 |
| act2_m | relu |
| dense | outputs=10 |
| act_output | softmax |

Other layers such as BatchNormalization and Flatten are not represented here for clarity. In this example, the reference model uses 8 bits for weights and activations and 16 bits for accumulators.

When the additional capability to search for a number of filters at the same time as the model is quantized is added, the KerasTuner package may be used as one example way to perform network searches according to the present disclosure. The KerasTuner package can perform random, hyperband, or Bayesian (Gaussian process) search of the hyperparameter space, but without loss of generality, a search could be carried out through other mechanisms (e.g., using reinforcement learning schemes). The main loop of network search, in one example, is performed as:

```
def create_hyper_model(model,
            filter_search,
            min_range=−2.0,
            max_range=2.0):
  def build( ):
    tag = { }
    filter_factor = 1.0
    if filter_search == “block”:
      filter_factor = choose_range(min_range, max_range)
    for layer in model.layers:
      quantizers = [ ]
      if has_trainable_parameters(layer):
        quantizers = [
          choose_quantizer(parameter)
          for parameter in layer.trainable_parameters]
      if filter_search == “layer”:
        filter_factor = choose_range(min_range, max_range)
      filters = int(layer.filters * filter_factor)
      tag[layer].append(
        quantize_layer(layer, filters, quantizers))
      if has_activation(layer):
        activation_quantizer = choose_quantizer(layer)
        tag[layer].append(
          quantize_activation(layer, activation_quantizer)
    qmodel = quantize_model(model, tag)
    energy_gain = energy(qmodel)
    score = accuracy * forgiving_factor(energy_gain)
    qmodel.compile(metrics=[score, “accuracy”])
    return qmodel
  return build
def fit(goal, model, filter_search, min_range=−2.0,
        max_range=2.0, *fit_params, **kw_fit_params):
  hyper_model = create_hyper_model(
    model, filter_search, min_range, max_range)
  kt = KerasTuner(goal, hyper_model)
  kt.fit(*fit_params, **kw_fit_params)
  qmodel = kt.get_ best_model( )
  return qmodel
```

In this algorithm, two types of filter_search are allowed, without loss of generality: one that performs filter search for the entire block (or model) being searched, and another one that adjusts the number of filters for each layer. The function choose_quantizer chooses one of the quantizers from a quantizer library templates such as, for example, the quantizers provided by QKeras. In some examples, a different quantizer may be chosen for one or more parameters of layers which contain the one or more parameters. For example, the above example chooses a quantizer for trainable parameters within a layer (e.g., weights, filters, and/or biases), and the quantizer may be the same or different for one or more of the layers and/or one or more of the parameters within the layer. The functions quantize_layer and quantize_activation map a layer to a quantization function, and quantize_model applies the quantization function to the reference model. The function choose range selects randomly a number between min_range and max_range.

The function forgiving_factor(energy_gain) refers to the scaling factor calculated above according to Equation (2). The fit function creates a hyper model object, and it invokes the search process, returning the best model found.

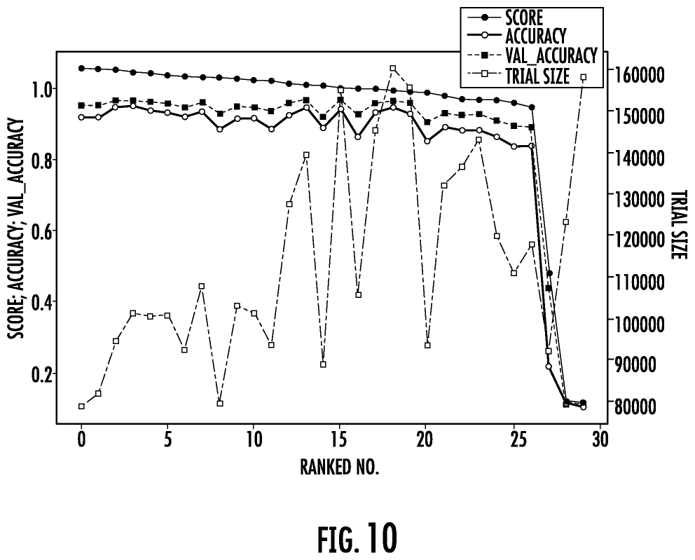

The winning searched model has 74% reduction in energy cost (as approximated with the size of the model), with the results of the trials presented in FIG. 10, where the results are ranked in descending order according to the calculated score. The quantization and adjusted filter sizes are as follows:

| stats: total=106992/413600 (−74.13%) | |
|---|---|
| conv2d_0_m | filters=12 quantized_bits(4,0,1) |
| act0_m | quantized_relu(3,0) |
| conv2d_1_m | filters=24 ternary(alpha=auto_po2, |
| | use_stochastic_rounding=1) |
| act1_m | quantized_relu(3,0) |
| conv2d_2_m | filters=96 binary(alpha=auto_po2, |
| use_stochastic_rounding=True) | |
| act2_m | binary |
| dense | outputs=10 quantized)bits(4,0,1) |
| | quantized_bits(4,2,0) |
| act_output | softmax |

Note that the initial two convolutional layers had a reduction in the number of filters, but an increased number of filters in the last layer. This indicates that, after the quantization, the number of filters may have become redundant in the first two layers, but it required more filters for the last layer (with respect to the score, which corresponds to an accuracy metric and the scaling function forgiving_factor, which includes terms of energy cost, which may be estimated or approximated by a number of bits).

A group search may be carried out, in some examples, as follows, where the groups are sorted by descending energy cost, and a network search is performed on each layer in the sorted order.

```
def create_hyper_model(model, group, filter_search,
            min_range=−2.0, max_range=2.0):
  def build( ):
    tag = { }
    filter_factor = 1.0
    if filter_search == “block”:
      filter_factor = choose_range(min_range, max_range)
    for layer in model.layers:
      if layer not in group:
        continue
      quantizers = [ ]
      if has_trainable_parameters(layer):
        quantizers = [
          choose_quantizer(parameter)
          for parameter in layer.trainable_parameters]
      if filter_search == “layer”:
        filter_factor = choose_range(min_range, max_range)
      filters = int(layer.filters * filter_factor)
      tag[layer].append(
        quantize_layer(layer, filters, quantizers))
      if has_activation(layer):
        activation_quantizer = choose_quantizer(layer)
        tag[layer].append(
          quantize_activation(layer, activation_quantizer))
    qmodel = quantize_model(model, tag)
    energy_gain = energy(qmodel)
    score = accuracy * forgiving_factor(energy_gain)
    qmodel.compile(metrics=[score, “accuracy”])
    return qmodel
  return build
def fit(
    goal, model, group_func, sort_group_by_decreasing_ energy,
    filter_search, min_range=−2.0,
    max_range=2.0, *fit_params, **kw_fit_params):
  qmodel = model.copy( )
  groups = group_func(model)
  if sort_group_by_decreasing_energy:
    groups = compute_energy_and_sort_decreasing_energy(groups)
  else:
    groups = sort_groups_from_user_specified_order(groups)
  for group in groups:
    hyper_model = create_hyper_model(
      model, group, filter_search, min_range, max_range)
    kt = KerasTuner(goal, hyper_model)
    kt.fit(*fit_params, **kw_fit_params)
      qmodel = kt.get_best_model( )
  return qmodel
```

Here, the fit function creates groups of layers from the original model, sorts them in descending order of energy, and searches for the best model, group by group. However, the groups may be ordered in any desired or specified order, such as from inputs to outputs.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for quantizing a neural network model while accounting for performance, the method comprising:
receiving, by a computing system comprising one or more computing devices, a reference neural network model;
modifying, by the computing system, the reference neural network model to generate a candidate neural network model, wherein the candidate neural network model is generated by selecting one or more values from a first searchable subspace and one or more values from a second searchable subspace, wherein the first searchable subspace corresponds to a quantization scheme for quantizing one or more values of the candidate neural network model, and the second searchable subspace corresponds to a size of a layer of the candidate neural network model;
evaluating, by the computing system, one or more performance metrics of the candidate neural network model; and
outputting, by the computing system, a new neural network model based at least in part on the one or more performance metrics.

2. The computer-implemented method of claim 1, wherein modifying, by the computing system, the reference neural network model to generate the candidate neural network model comprises:
selecting, by the computing system, the one or more values from the first searchable subspace and the one or more values from the second searchable subspace using a controller model.

3. The computer-implemented method of claim 2, wherein outputting, by the computing system, the new neural network model comprises:
updating, by the computing system, the controller model based at least in part on the one or more performance metrics; and
generating, by the computing system, the new neural network model using the updated controller model.

4. The computer-implemented method of claim 2, wherein the controller model comprises a reinforcement learning agent.

5. The computer-implemented method of claim 1, wherein the quantization scheme is selected from binary, modified binary, ternary, exponent, and mantissa quantization schemes.

6. The computer-implemented method of claim 1, wherein the second searchable subspace corresponds to at least one of a quantity of output units and a quantity of filters.

7. The computer-implemented method of claim 1, wherein the one or more performance metrics comprises an estimated energy consumption of the candidate neural network model directly computed using one or more look up tables or estimation functions.

8. The computer-implemented method of claim 1, wherein the one or more performance metrics comprises a real-world energy consumption associated with implementation of the candidate neural network model on a real-world device.

9. The computer-implemented method of claim 2, wherein outputting, by the computing system, the new neural network model comprises:
determining, by the computing system, a reward based at least in part on the one or more performance metrics; and
modifying, by the computing system, one or more parameters of the controller model based on the reward.

10. The computer-implemented method of claim 2, wherein the controller model is configured to generate the candidate neural network model through performance of evolutionary mutations, and wherein modifying, by the computing system, the reference neural network model to generate a new neural network model comprises:
determining, by the computing system, whether to retain or discard the candidate neural network model based at least in part on the one or more performance metrics.

11. The computer-implemented method of claim 1, wherein the one or more performance metrics comprises a scaling factor which negatively correlates to a difference in energy consumption between the candidate neural network model and the reference neural network model.

12. The computer-implemented method of claim 1, wherein the reference neural network model comprises a plurality of layers, and wherein the method further comprises:
evaluating, by the computing system, an energy cost associated with each of two or more of the plurality of layers;
modifying, by the computing system, each of the two or more plurality of layers in an order determined by a descending order of the energy costs associated with each of the two or more of the plurality of layers.

13. The computer-implemented method of claim 12, wherein modifying, by the computing system, each of the two or more plurality of layers comprises:
selecting, by the computing system, a first quantization scheme for quantizing values within a first layer and a second quantization scheme for quantizing values within a second layer, wherein the first quantization scheme is different than the second quantization scheme, and wherein the first layer is associated with a first energy cost higher than a second energy cost associated with the second layer.

14. A computing system comprising:
one or more processors;
a controller model configured to modify neural network models to generate new neural network models; and
one or more non-transitory computer-readable media that collectively store instructions that, when executed by the one or more processors, cause the computing system to perform operations, the operations comprising:
receiving a reference neural network model as an input to the controller model;
modifying the reference neural network model to generate a candidate neural network model, wherein the candidate neural network model is generated by selecting one or more values from a first searchable subspace and one or more values from a second searchable subspace, wherein the first searchable subspace corresponds to a quantization scheme for quantizing one or more values of the candidate neural network model, and the second searchable subspace corresponds to a size of a layer of the candidate neural network model;
evaluating one or more performance metrics of the candidate neural network model; and
outputting a new neural network model based at least in part on the one or more performance metrics.

15. The computing system of claim 14, wherein outputting the new neural network model comprises:
updating the controller model based at least in part on the one or more performance metrics; and
generating the new neural network model using the updated controller model.

16. The computing system of claim 14, wherein the one or more performance metrics comprise an estimated energy cost of the candidate neural network model.

17. The computing system of claim 14, wherein the one or more performance characteristics comprises a real-world energy cost associated with implementation of the candidate neural network model on a real-world device.

18. The computing system of claim 14, wherein updating the controller model based at least in part on the one or more performance characteristics comprises:
determining a reward based at least in part on the one or more performance characteristics; and
modifying one or more parameters of the controller model based on the reward.

19. The computing system of claim 14, wherein:
the quantization scheme is selected from binary, modified binary, ternary, exponent, and mantissa quantization schemes; and
the second searchable subspace corresponds to at least one of a quantity of output units and a quantity of filters.

20. One or more non-transitory computer-readable media that store instructions that when executed by a computing system comprising one or more computing devices cause the computing system to perform operations, the operations comprising:
receiving, by the computing system, a reference neural network model;
modifying, by the computing system, the reference neural network model to generate a candidate neural network model, wherein the candidate neural network model is generated by selecting one or more values from a first searchable subspace and one or more values from a second searchable subspace, wherein the first searchable subspace corresponds to a quantization scheme for quantizing one or more values of the candidate neural network model, and the second searchable subspace corresponds to a size of a layer of the candidate neural network model; and
evaluating, by the computing system, one or more performance metrics of the candidate neural network model.
